(19) United States
(12) Patent Application Publication
(10) Pub. No.: US 2024/0305484 A1
(43) Pub. Date: Sep. 12, 2024

(54) TASK MINING DATA NETWORK ARCHITECTURE INCORPORATING A PRIVATE OR HYBRID BLOCKCHAIN

(71) Applicant: INTERNATIONAL BUSINESS MACHINES CORPORATION, ARMONK, NY (US)

(72) Inventors: Logan Bailey, Sandy Springs, GA (US); Zachary A. Silverstein, Austin, TX (US); Jeremy R. Fox, Austin, TX (US); Tiberiu Suto, Franklin, NY (US)

(21) Appl. No.: 18/182,356

(22) Filed: Mar. 12, 2023

(51) Int. Cl. H04L 9/00; H04L 9/32

(52) U.S. Cl. CPC H04L 9/50; H04L 9/3247

(57) ABSTRACT

A computer-implemented method of storing task mining data can include recording user inputs data and interactions data at a computer terminal. The user inputs data and the interactions data can be stored a distributed ledger blockchain, where permissions are assigned to network nodes to read from or write to the distributed ledger blockchain.

### BACKGROUND

### Technical Field

The present disclosure generally relates to data capture and sharing technologies, and more particularly, to a computer-implemented method, a computer system, and a computer program product for utilizing a multi-nodal network in collaboration with a cryptographically secure distributed ledger for facilitation of capture and share of task mining data across a public or private network.

### Description of the Related Art

Task mining is the process of monitoring a user's interaction logs on their file system to “discover” tasks that a user executes and to turn them into automatable steps. Often times, task mining goes hand in hand with process mining. Conventionally, task mining requires a definite integration to a singular environment and, on top of that, coordinated synchronicity with a server client architecture, complicating task mining between individuals, teams, and companies who have similar repeatable tasks.

### SUMMARY

In one embodiment, a computer-implemented method of storing task mining data can include recording user inputs data and interactions data at a computer terminal. The user inputs and interactions data can be stored in a distributed ledger blockchain, where permissions are assigned to network nodes to read from or write to the distributed ledger blockchain.

In one embodiment, a computer implemented method for utilizing a multi-nodal network in collaboration with a cryptographically secure distributed ledger for facilitation of capture and share of task mining data across a public or private network includes recording user inputs and interactions data at a computer terminal. The user inputs and interactions data can be stored as task mining logs on the cryptographically secure distributed ledger. Permissions can be assigned to network nodes to read from or write to the cryptographically secure distributed ledger. The task mining logs can be stored locally for later transmission or are immediately encoded with a digital signature and broadcasted to be recorded on cryptographically secure distributed ledger.

In some embodiments, the permissions are received from an administrator or an authorized network participant and sent to the network nodes. In some embodiments, the permissions include a read permission or a write permission to read data from or write data to the distributed ledger blockchain.

In one embodiment, a non-transitory computer readable storage medium tangibly embodying a computer readable program code having computer readable instructions that, when executed, causes a computer device to carry out a method for utilizing a multi-nodal network in collaboration with a cryptographically secure distributed ledger for facilitation of capture and share of task mining data across a public or private network, where the method includes recording user inputs and interactions data at a computer terminal. The user inputs and interactions data can be stored as task mining logs on the cryptographically secure distributed ledger. Permissions can be assigned to network nodes to read from or write to the cryptographically secure distributed ledger.

By virtue of the concepts discussed herein, systems and methods are provided for utilizing task mining at a greater scope than singular users via a server client architecture. Aspects of the present disclosure can utilize a multi-nodal network in collaboration with a cryptographically secure distributed ledger for facilitation of capture and share of task mining data across a public or private network. By doing so, task mining systems and methods can be improved by providing immutable data storage on a consortium blockchain within a distributed system to provide permissioned read/write access to the data for both participants on the local network or across an enterprise.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a block diagram representing a process for task mining data storage and retrieval, according to an illustrative embodiment.

FIG. 2 shows a schematic representation of multiple enterprises utilizing the process of FIG. 1 on a blockchain, according to an illustrative embodiment.

FIG. 3 is a functional block diagram illustration of a computer hardware platform that can be used to implement the method for utilizing a multi-nodal network in collaboration with a cryptographically secure distributed ledger for facilitation of capture and share of task mining data across a public or private network, according to an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Aspects of the present disclosure provide a system and method for utilization of a multi-nodal network in collaboration with a cryptographically secure distributed ledger, such as a consortium blockchain, for facilitation of capture and share of task mining data across a public or private network. In some embodiments, a module is provided to record event data, such as user inputs data and interactions data, and to interact and store event data on a distributed ledger blockchain. The data stored is not only immutable but may be utilized across the network.

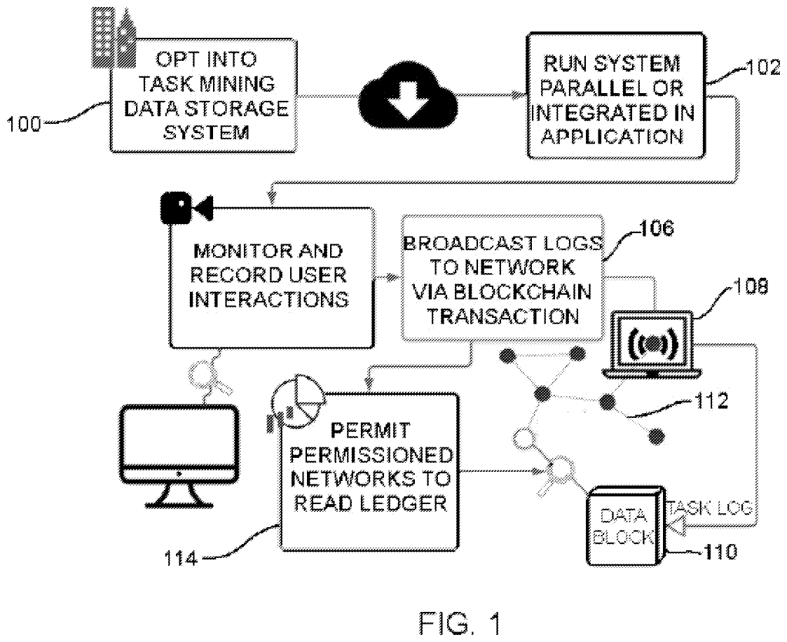

Referring to FIG. 1, at block 100, a software service provider, enterprise, or entity can opt into using the task mining data storage system according to embodiments of the present disclosure. At this stage, the system can initiate using the task mining data storage system securely with a blockchain and provide a level of anonymization as preferred by the user.

At block 102, the task mining data storage system can include a software module that can be configured to run parallel to or integrated within an application. The software module can persist at the operating system (OS) level, can persist at the application level, can persist containerized on a cloud server, or may be provisioned as a serverless function to the user.

At block 104, the task mining data storage system can monitor and record user input and interaction data relative to its assigned purpose. For example, a user can interact with enterprise resource planning (ERP) software with an integrated software module, according to the present disclosure, where the task mining data logs can be stored locally or immediately broadcasted to a network for storage on a distributed ledger, such as a consortium blockchain, as shown at block 106. As shown in FIG. 1, a user terminal 108 may provide a data block 110 for uploading to the blockchain 112.

The task mining data storage system can begin to record the user's action, first storing session data on the local file system, and then batch uploading the derived session data. In some embodiments, the software module may perform OCR on the screen contents before the user input and then correlate the user input to the screen contents preceding the action. This data, for example, can be fed into a supervised machine learning model in order to determine data dependent user patterns so that the respective domain logic can later be incorporated into the automation, as illustrated, for example, in block 114.

For example, when processing accounts payable checks under $1000, the user may automatically approve and process payment, while for values of $1000 and over, the user sends it for management approval. By determining the diverging processing paths depending on data values, the software module can add or recommend the respective business logic into the automation scripting. In another example, the system can be used to store task mining data across an enterprise so that a software company may use the software use data for software improvement.

In some embodiments the computing device can receive an acknowledgement from an external source (e.g., an authorized user) that the data is reviewed for anything private or sensitive before allowing data to go forward to the blockchain. In some embodiments, private or sensitive data may be replaced with a tokenized identifier of such data.

In some embodiments, the task mining logs are stored locally for later transmission or immediately encoded with a digital signature and broadcast to the network to be recorded on the distributed ledger. The later transmission may include after a confirmed process or after a specific point in time, for example. In some embodiments the files can be uploaded instantly, however, such instant uploading is typically performed at the per tenant level and not at the per user level.

In some embodiments, data can be recorded chronologically on a distributed ledger blockchain utilizing, but not limited to, one of the following methods. (1) A valid network node with assigned authority; or (2) A valid network node derived from a Byzantine fault tolerant (BFT) consensus algorithm. Permissioned network nodes may read ledger data to derive statistical patterns, usage metrics, and other relevant data. For example, a customer relationship management (CRM) software provider can derive user metrics for software functions, and make changes or adjustments based on data. In another example, an enterprise can be able to derive metrics or specific event log data from mined tasks related to their ERP to facilitate managerial planning or improve operational communication across departments.

In some embodiments, the task mining data storing system can perform aggregated data processing live on the blockchain to gather performance metrics of the system, process name or other information, business data related to the process in scope including but not limited to business object names, and/or cost associated with each processing instance. In some embodiments, the aggregated information can be processed and analyzed through central process mining, which gives the users of the system, according to the present disclosure, insights into their task and how it compares globally. In some embodiments specific software, vendors, or metadata may also be analyzed. In one example, nodes authorized to retrieve ledger data may integrate directly with external process mining software or related data aggregation/modeling software.

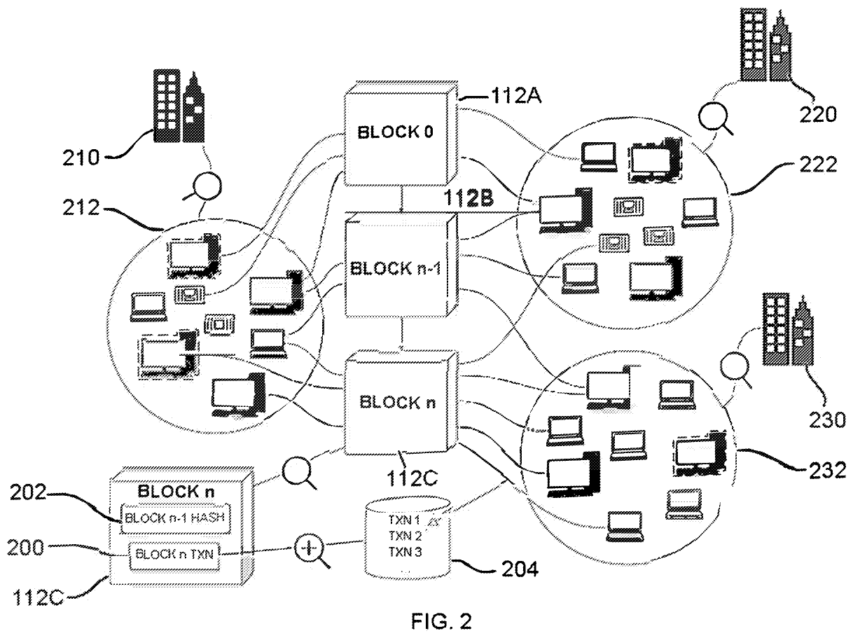

Referring to FIG. 2, a distributed ledger, such as blockchain 112 can include block zero 112A, block n-1 112B and block n 112C, as illustrated. Various enterprises can have a number of users utilizing the task mining data storage system according to embodiments of the present disclosure. For example, enterprise A 210 may have users 212, enterprise B 220 may have users 222, and enterprise C 230 may have users 232. Task mining data may be stored for the users 212, 222, 232 on the blockchain 112. Each of the users 212, 222, 232 may operate various types of computer terminals that may utilize the task mining data storage system according to aspects of the present disclosure. As discussed above, the data may be written to the blockchain 112 in a chronological order.

Block n 112C is illustrated in detail, where transactions 204 may be written to the block n 112C in a transaction register 200 and block n 112C can also include a hash 202 of the previous block, in this case, block n-1 112B.

The task mining data storage system can be used in various capacities. For example, a company that offers a software package may, with the end user permission, use the system of the present disclosure to collect data concerning user interaction with their software. This data may then be later analyzed for product improvement by the software company, or may be used by the enterprise itself to determine, for example, how users engage with the software and how process flows may be improved.

In another example, the above software company may capture data from a plurality of enterprises that use their software. The software company may determine which enterprises to share the collected data and permissions may be granted to such enterprises to permit access to their own task mined data and/or to task mined data of other enterprises, where appropriate.

Aspects of the present disclosure can provide a task mining data storing system that records user inputs and interactions and stores event data on a distributed ledger blockchain. In some embodiments, the system can persist as a software implementation in parallel with or integrated within an application to function as a network node to the distributed ledger.

In some embodiments, network nodes can be assigned permissions, such as read/write, by an administrator or by an authorized network participant. In this embodiment, Byzantine fault tolerance is not used for updating the blockchain, but, instead, permissions are used.

Aspects of the present disclosure can provide a task mining data storing system that can broadcast event data to the blockchain encoded with a device cryptographic signature for source verification. In some embodiments, a digital signature algorithm can be utilized to assign network identity to participating devices on the network.

Aspects of the present disclosure can provide a task mining data storage system where the encoded event data is stored in chronological order in cryptographically linked data blocks utilizing Merkle trees. A Merkle tree, or a hash tree, is a tree in which every “leaf” (node) is labelled with the cryptographic hash of a data block, and every node that is not a leaf (called a branch, inner node, or inode) is labelled with the cryptographic hash of the labels of its child nodes. A hash tree allows efficient and secure verification of the contents of a large data structure. A hash tree is a generalization of a hash list and a hash chain. Demonstrating that a leaf node is a part of a given binary hash tree includes computing a number of hashes proportional to the logarithm of the number of leaf nodes in the tree. Conversely, in a hash list, the number is proportional to the number of leaf nodes itself. A Merkle tree is therefore an efficient example of a cryptographic commitment scheme, in which the root of the tree is seen as a commitment and leaf nodes may be revealed and proven to be part of the original commitment.

In some embodiments, data blocks may be generated by a selected validator network node with utilization of a Byzantine fault-tolerant (BFT) consensus algorithm. Such a BFT consensus algorithm may be useful, for example, when using a public blockchain, to achieve fault tolerance without designated validator nodes. In some embodiments, data blocks may be generated by a trusted node or quorum of nodes to ensure data validity. In some embodiments, network node participants may have restrictions on permissions to read or write data to the distributed ledger.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

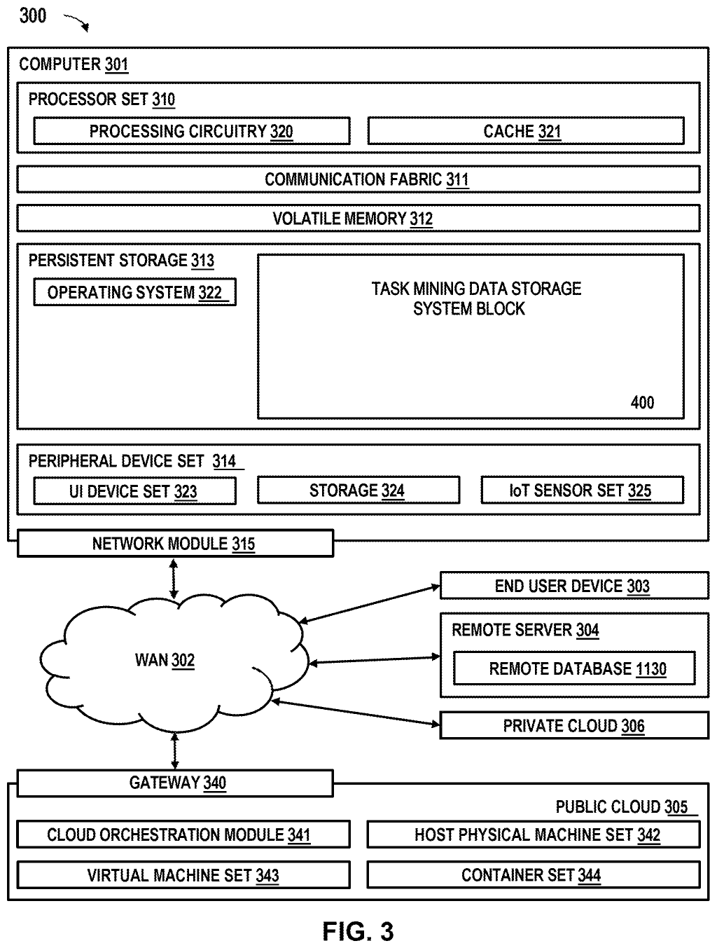

Referring to FIG. 3, computing environment 300 includes an example of an environment for the execution of at least some of the computer code involved in performing the inventive methods, such as a task mining data storing system block 400. In addition to block 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 400, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 400 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 400 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail above, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,”“comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of capturing and sharing task mining data across a network, the method comprising:
recording user inputs data and interactions data at a computer terminal;
sending the user inputs data and the interactions data to be stored on a distributed ledger blockchain; and
assigning permissions to network nodes to read from or write to the distributed ledger blockchain.

2. The method of claim 1, wherein the distributed ledger blockchain is a consortium blockchain.

3. The method of claim 1, further comprising persisting a software implementation in parallel with or integrated within an application to function as one of the network nodes to the distributed ledger blockchain.

4. The method of claim 3, further comprising:
receiving the permissions from an administrator or an authorized network participant; and
sending the permissions to the network nodes.

5. The method of claim 4, wherein the permissions include a read permission or a write permission to read data from or write data to the distributed ledger blockchain.

6. The method of claim 1, further comprising broadcasting the user inputs data and the interactions data to the distributed ledger blockchain with a device cryptographic signature for source verification.

7. The method of claim 6, further comprising utilizing a digital signature algorithm to assign a network identity to participating devices on a network.

8. The method of claim 1, further comprising storing the user inputs data and interactions data in chronological order in cryptographically linked data blocks on the distributed ledger blockchain.

9. The method of claim 8, further comprising using Merkle trees to store the user inputs data and the interactions data in chronological order in cryptographically linked data blocks on the distributed ledger blockchain.

10. The method of claim 9, further comprising generating data blocks of the user inputs data and the interactions data with a Byzantine fault tolerant consensus algorithm.

11. The method of claim 9, further comprising generating data blocks of the user inputs data and the interactions data by a trusted node or a quorum of the network nodes to the distributed ledger blockchain to ensure data validity.

12. The method of claim 1, further comprising restricting the permissions to read from or write to the distributed ledger blockchain by participants on the network nodes.

13. A computer implemented method for utilizing a multi-nodal network in collaboration with a cryptographically secure distributed ledger for facilitation of capture and share of task mining data across a public or private network, the method comprising:
recording user inputs data and interactions data at a computer terminal;
sending the user inputs data and the interactions data to be stored on the cryptographically secure distributed ledger; and
assigning permissions to network nodes to read from or write to the cryptographically secure distributed ledger,
wherein task mining logs are stored locally for later transmission or are immediately encoded with a digital signature and broadcast to be recorded on the cryptographically secure distributed ledger.

14. The method of claim 13, further comprising broadcasting the task mining logs to the cryptographically secure distributed ledger with a device cryptographic signature for a source verification.

15. The method of claim 13, further comprising storing the user inputs data and the interactions data in chronological order in cryptographically linked data blocks on the cryptographically secure distributed ledger.

16. The method or claim 15, further comprising using Merkle trees to store the user inputs data and the interactions data in chronological order in cryptographically linked data blocks on the cryptographically secure distributed ledger.

17. A non-transitory computer readable storage medium tangibly embodying a computer readable program code having computer readable instructions that, when executed, causes a computer device to carry out a method for utilizing a multi-nodal network in collaboration with a cryptographically secure distributed ledger for facilitation of capture and share of task mining data across a public or private network, the method comprising:
recording user inputs data and interactions data at a computer terminal;
sending the user inputs data and the interactions data to be stored on the cryptographically secure distributed ledger; and
assigning permissions to network nodes to read from or write to the cryptographically secure distributed ledger.

18. The non-transitory computer readable storage medium of claim 17, wherein the task mining logs are stored locally for later transmission or are immediately encoded with a digital signature and broadcasted to be recorded on the cryptographically secure distributed ledger.

19. The non-transitory computer readable storage medium of claim 17, the method further comprising broadcasting the task mining logs to the cryptographically secure distributed ledger with a device cryptographic signature for source verification.

20. The non-transitory computer readable storage medium of claim 17, the method further comprising storing the user inputs data and the interactions data in chronological order using Merkle trees in cryptographically linked data blocks on the cryptographically secure distributed ledger.
